(19) United States
(12) Patent Application Publication
(10) Pub. No.: US 2023/0107358 A1
(43) Pub. Date: Apr. 6, 2023

(54) MODULAR FISHING-LURE SYSTEM AND METHODS OF MANUFACTURE

(71) Applicant: ABALT Custom Lures LLC, Azle, TX (US)

(72) Inventor: Michele Trammell, Azle, TX (US)

(73) Assignee: ABALT Custom Lures LLC, Azle, TX (US)

(21) Appl. No.: 17/993,972

(22) Filed: Nov. 24, 2022

Related U.S. Application Data
(63) Continuation-in-part of application No. 17/007,853, filed on Aug. 31, 2020.

(51) Int. Cl. A01K 85/00; A01K 85/10

(52) U.S. Cl. CPC A01K 85/1851; A01K 85/10; A01K 85/1831

(57) ABSTRACT

A fishing lure system includes a link and link enclosure and a variety of attachments. The enclosure includes a channel dimensioned to snugly fit over the link and defined by walls of a rigid material such as to resist deformation of the link when the link is under stress (e.g., a pulling fish). The link may be attached to a spinnerbait frame that is constructed of a specially looped elongated component (e.g., wire) forming two legs at roughly 90 degrees to each other. The frame and loop are formed through a series of wire bends that support the 90 degree angle against deformation when the frame is under stress. The link may be attached to a swimbait body constructed with a cavity within which the lure’s hook is substantially concealed. The link or frame may be attached to a spinnerbait blade comprising an outer blade encapsulating and inner feature.

### CROSS-REFERENCE TO RELATED APPLICATIONS

This application is a continuation-in-part of U.S. Pat. Application No. 17/007,853, filed on Aug. 31, 2020.

### BACKGROUND

The present disclosure relates to fishing equipment, and more particularly to fishing lure systems and methods of creating custom fishing lures.

Fishing lures may be used to catch fish effectively. Fishermen typically bring many different types of fishing lures on fishing expeditions in order to effectively fish for different types of fish in different conditions. When using fishing lures on a fishing expedition, fishermen are typically limited to fishing effectively in conditions that the fishing lures that they brought were designed for. If any component of these conventional fishing lures breaks, often the entire conventional lure is discarded.

### SUMMARY

In accordance with one aspect of the present disclosure, a link fishing lure system is provided which allows a fisherman to customize a fishing lure for different fishing conditions using various enclosures, connecting links, eye capsules, and attachments. This may enable fishermen to carry fewer lures on fishing expeditions. In some implementations, the link fishing lure system may allow for replacement of attachments, enclosures, connecting links, and eye capsules. When part of the link fishing lure system breaks, such as an attachment, enclosure, connecting link, or eye capsule, the broken part of the link fishing lure system may be replaced. The user may also interchange lure attachments.

In some implementations, the link fishing lure system may include a channel that extends through the enclosure. The channel may be operable to removably house a connecting link comprising a plurality of ends. When housed within the channel, the connecting link of the link fishing lure system may be secured within the channel when an attachment is coupled to at least one of the connecting link’s ends.

In some implementations, the link fishing lure system may include an enclosure comprising a channel operable to house a connecting link. The connecting link may be secured within the enclosure when an attachment is coupled to the connecting link. The link fishing lure system may contain a means for connecting an attachment. The means for connecting may be removably disposed within the channel.

In some implementations, the connecting link may be shaped like an open geometric stadium. In some implementations, the connecting link may have at least one end shaped like an open figure eight. In some implementations, the connecting link may have an opening. In some implementations, the enclosure may be shaped like part of a fish. In some implementations, the connecting link may be slidably moveable within the channel. In some implementations, the enclosure may contain a weighting compartment operable to house a weight. In some implementations, an eye canal, which may be operable to house an eye capsule, may extend through the enclosure and intersect the channel. In some implementations, the eye capsule may be secured within the eye canal when the connecting link is inserted into the channel and secured within the enclosure. In some implementations, the link fishing lure system may contain a means for producing sound when the system is in use.

In some implementations, a rigid enclosure is used to structurally reinforce another component. For example, a link enclosure may include within it a channel defined by walls constructed of rigid material. The channel is dimensioned slightly larger than the link it is to enclose and deformation of the link due to stress (e.g., from a fish or entangled lure) is limited by the walls of the channel. In another example, an open barrel may include within itself a channel defined by walls constructed of a rigid material. The channel is dimensioned slightly larger than portions of an elongated component (e.g., length of wire) bent back on itself to form an open loop. When the portions are within the barrel interior, the barrel holds the loop closed and the friction between the portions and the interior walls holds the barrel in place, thus “locking” the loop in the closed position and resisting deformation of the loop when under stress.

In some implementations, a link attachment may be constructed of an elongated component bent back on itself in such a way that movement of one portion of the component is impeded by another portion. For example, a spinnerbait frame having two legs at roughly 90 degrees to each other may be constructed of a strand of wire looped about itself to form a semi-flexible joint between the legs where deformation of the frame, and in particular the angle between the legs (e.g., from a fish or entangled lure), is resisted by the contact of the wire with itself.

In some implementations, a link attachment may be constructed of a component structured with a cavity to receive within itself a hook and thereby substantially conceal the hook. For example, a swimbait component may be in the form of a fish body having cavities in the belly portion and dorsal-fin portion. A hook may be place through the body such that a substantial portion of the hook is encompassed by the body walls defining the belly cavity and the hook’s barb portion is encompassed by the dorsal-fin walls defining the dorsal-fin cavity. In some embodiments of such an attachment, the body may include a tail fin comprising roughly perpendicular planar surfaces.

In some implementations, a link attachment may be constructed of a first component structured to encapsulate a second component. For example, a spinnerbait blade may include an outer blade that encapsulates an interior feature, such as a inner blade or a fly or feather or the like.

The details of one or more implementations are set forth in the accompanying drawings and the description below. Other features, objects, and advantages of the implementations will be apparent from the description and drawings.

### BRIEF DESCRIPTION OF THE DRAWINGS

These and other features, aspects, and advantages of the present invention will become better understood with reference to the following description, appended claims, and accompanying drawings where:

FIG. 1 illustrates an exploded perspective view of a link fishing lure system according to the present disclosure.

FIG. 2 illustrates an exploded side view of the link fishing lure system of FIG. 1.

FIG. 3 illustrates an end view of the back of an enclosure of the link fishing lure system of FIG. 1.

FIG. 4 illustrates an exploded perspective view of the link fishing lure system of FIG. 1 with attachments.

FIG. 5 illustrates a perspective view of another implementation of a link fishing lure system according to the present disclosure.

FIG. 6 illustrates an exploded perspective view of yet another implementation of a link fishing lure system with a connecting link that has an end shaped like an open figure eight according to the present disclosure.

FIG. 7A illustrates an exploded perspective view of yet another implementation of a link fishing lure system with a channel that can accept a connecting link in multiple planes within the enclosure according to the present disclosure.

FIG. 7B illustrates an exploded perspective view of yet another implementation of a link fishing lure system with a channel that can accept a connecting link in multiple planes within the enclosure according to the present disclosure.

FIG. 8A illustrates an implementation of a connecting link with an end that has an opening loop that can couple an attachment when the user exerts pressure on the opening loop.

FIG. 8B illustrates another implementation of a connecting link with an end shaped like an open figure eight.

FIG. 8C illustrates yet another implementation of a connecting link shaped like a geometric stadium with an opening.

FIG. 8D illustrates still another implementation of a connecting link shaped like a geometric stadium with an opening having angled ends.

FIG. 8E illustrates yet another implementation of a connecting link shaped like a geometric stadium with no openings and an integrated hook at an end.

FIG. 8F illustrates still another implementation of a connecting link shaped like a geometric stadium with an opening and a weight securing prong.

FIG. 8G illustrates yet another implementation of a connecting link with six ends.

FIG. 9 illustrates an exploded perspective view of yet another implementation of a link fishing lure system with a connecting link with a weight securing prong and a channel that can accept a connecting link in multiple planes within the enclosure according to the present disclosure.

FIG. 10 illustrates an exploded perspective view of yet another implementation of a link fishing lure system with a three-dimensional connecting link according to the present disclosure.

FIG. 11 illustrates an end view of the back of an enclosure of a link fishing lure system with both a connecting link channel and an eye canal according to the present disclosure.

FIG. 12 illustrates an exploded side view of the link fishing lure system of FIG. 11.

FIG. 13 illustrates an exploded perspective view of a link fishing lure system with an eye canal and an eye capsule with rattles according to the present disclosure.

FIG. 14 illustrates an exploded perspective view of a link fishing lure system with an eye canal and an eye capsule with rattling eyes according to the present disclosure.

FIG. 15 illustrates an exploded perspective view of a link fishing lure system with an eye canal and a dumbbell eye capsule according to the present disclosure.

FIG. 16A illustrates an implementation of an eye capsule with rattles

FIG. 16B illustrates an implementation of an eye capsule with rattles and a wall.

FIG. 16C illustrates an implementation of an eye capsule with rattling eyes.

FIG. 16D illustrates an implementation of a dumb-bell eye capsule.

FIGS. 17A-17C illustrate various views of an exemplary link engaging a hook.

FIGS. 18A-18B illustrate an exemplary link outside of an enclosure: not under tension and under tension, respectively.

FIGS. 19A-19B are side and sectional views, respectively, illustrating an exemplary link secured in an exemplary link enclosure.

FIGS. 20A-20E are various views illustrating an exemplary spinnerbait-frame link attachment with barrel-lock clip-on connecters.

FIG. 21 illustrates another exemplary spinnerbait-frame link attachment with barrel-lock clip-on connecters.

FIGS. 22A-22B illustrates an exemplary line attachment with barrel-lock clip-on connecters.

FIG. 23 illustrates an exemplary spinnerbait constructed using exemplary link, link enclosure, and a spinner-frame-attachment components.

FIGS. 24A-24E illustrate an exemplary swimbait constructed using exemplary link, link enclosure, and hook-attachment components.

FIGS. 25A-25C illustrate an exemplary spinnerbait blade constructed with a first blade encapsulated by a second blade.

FIG. 26 illustrates an exemplary spinnerbait blade with a fly (real or simulated) encapsulated within the blade.

FIG. 27 illustrates an exemplary spinnerbait blade with a feather (real or simulated) encapsulated within the blade.

FIG. 28 illustrates an exemplary spinnerbait constructed using exemplary link, link enclosure, and a spinner-frame-attachment components.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

### Link and Enclosure System

Implementations of the present disclosure generally provide a link fishing lure systems and methods for creating a custom fishing lure. When parts of the link fishing lure system break, users may replace the individual broken components instead of replacing the entire link fishing lure system. The link fishing lure system may enable users to create customized lures using various attachments that may be adapted for specific fishing conditions and for catching specific species of fish. The customizability of the link fishing lure system may allow users to use less fishing lure equipment.

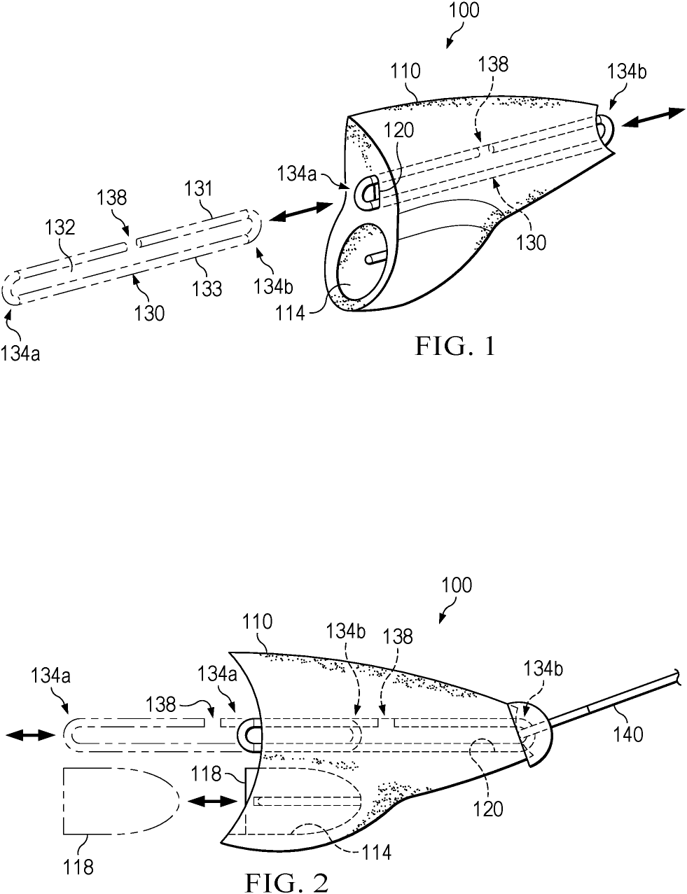

FIG. 1 illustrates one implementation of a link fishing lure system 100 with no attachments coupled to the link fishing lure system 100. As illustrated in FIG. 1, a link fishing lure system 100 comprises an enclosure 110 with a channel 120 operable to removably house a connecting link 130. The enclosure 110 forms the exterior portion of the fishing lure and may generally be shaped like part of a fish, such as a fish head and/or a fish body. The enclosure 110 may optionally contain a weighting compartment 114 that houses a weight 118. The channel 120 may extend through the interior of the enclosure 110 and along its entire length. The connecting link 130 may comprise a body 132 with ends 134a, 134b, and an opening (or “gap”) 138 in the body 132. In the implementation shown in FIG. 1, the body 132 of the connecting link 130 is shaped like a long oval, also referred to as an open geometric stadium, such that the ends 134a, 134b of the connecting link 130 are shaped like half circles coupled to substantially straight segments 131, 133 of the body 132. In various implementations, the optional opening 138 in the body 132 may be positioned on either of the substantially straight segments 131, 133, anywhere along the portion where the segments 131, 133 will be positioned within the channel 120 when the connecting link 130 is housed within the enclosure 110.

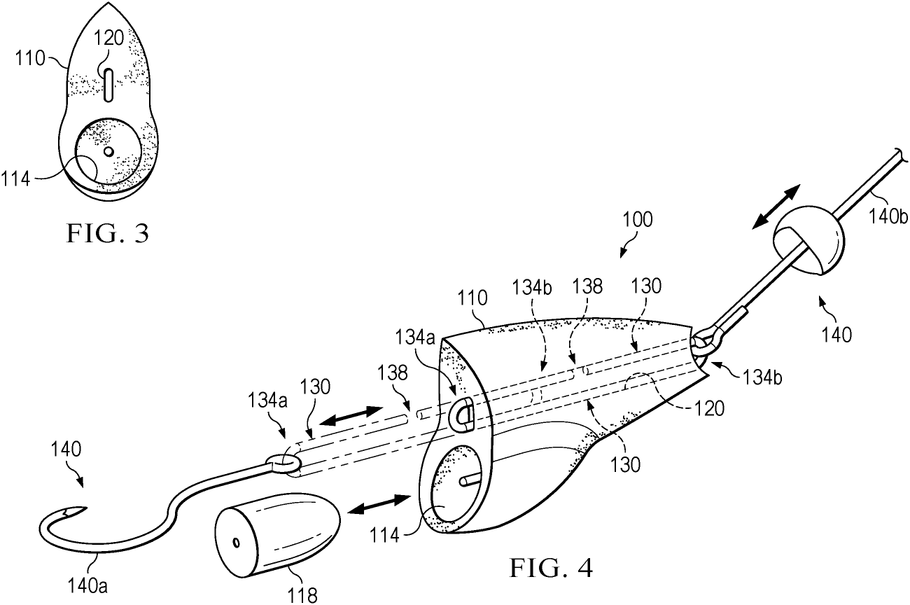

FIG. 2 illustrates a side view of the link fishing lure system 100 of FIG. 1. When the connecting link 130 is slid into the channel 120, the connecting link 130 may protrude past the enclosure 110 on both ends 134a-b of the connecting link. FIG. 3 illustrates a back view of the enclosure 110 of FIG. 1. The channel 120 has dimensions sufficient to slide the connecting link 130 into the channel 120. The weighting compartment 114 has dimensions sufficient to house a weight 118.

FIG. 4 illustrates the link fishing lure system 100 of FIG. 1 with attachments 140. The attachments 140 may have a variety of coupling mechanisms, including clip-on or eye style attachments. Clip-on attachments 140 can couple to the connecting link 130 without requiring an opening 138 in the connecting link 130. Clip-on attachments 140 have temporary openings in their coupling mechanism that allows the clip-on attachment to couple to the connecting link 130. A clip-on attachment 140 can be coupled directly on an end 134a-b of the connecting link 130 or can be threaded through the opening 138 in the connecting link 130. Eye attachments 140 have no temporary openings in their coupling mechanism that allows the attachment to couple to the connecting link. Therefore, eye attachments 140 require an opening 138 in the connecting link 130 to couple to the connecting link 130. An eye attachment 140 can be coupled to the connecting link 130 by threading the eye of the attachment through the opening 138 in the connecting link 130.

In an implementation, the connecting link 130 is secured within the channel 120 of the enclosure 110 by coupling one or more attachments 140 to one or more of the ends 134a, 134b of the connecting link 130. The connecting link is secured within a channel of the enclosure when the design of the channel and connecting link, along with one or more attachments coupled at the ends of the connecting link, cause the connecting link to be irremovably positioned within the channel and enclosure when a force-which is insufficient to cause damage to the connecting link, channel, enclosure, or attachment-is applied to any or multiple ends of the connecting link. Depending on the coupling mechanism of the attachments 140, the attachments 140 can be coupled to the connecting link 130 by coupling directly to the ends 134a, 134b of the connecting link 130 or the attachments 140 can be threaded through the opening 138 in the connecting link 130. If an implementation of the connecting link 130 omits an opening 138 in the body 132, then clip-on attachments 140 may be used to secure the connecting link 130 within the channel 120 of the enclosure 110.

In one implementation, the connecting link 130 in the fishing lure system 100 illustrated in FIG. 4 may be secured by first threading an attachment 140, such as attachment 140a, through the opening 138 in the connecting link 130 until the attachment 140a reaches end 134a. The opposite end 134b of the connecting link 130 without an attachment 140 may then be inserted into the channel 120 until the end 134b of the connecting link 130 without an attachment 140 protrudes past the enclosure 110. An end 134a-b of the connecting link 130 protrudes past the enclosure 110 when the end 134a-b is not prohibited by the enclosure 110 from coupling to an attachment 140. A clip-on attachment 140, such as attachment 140b, may then be coupled to the opposite end 134b of the connecting link 130 without an attachment 140. Once an attachment 140, such as attachment 140a and attachment 140b, is coupled to each end 134a-b of the connecting link 130, the connecting link 130 is secured within the channel 120 and within the enclosure 110.

In another implementation, the connecting link 130 in the fishing lure system 100 illustrated in FIG. 4 may be secured by inserting the connecting link 130 into the channel 120 until the leading end 134b of the connecting link 130 protrudes past the enclosure 110. Clip-on attachments 140 may then be coupled to both ends 134a-b of the connecting link 130. Once an attachment 140 is coupled to each end 134a-b of the connecting link 130, the connecting link 130 is secured within the channel 120 and within the enclosure 110.

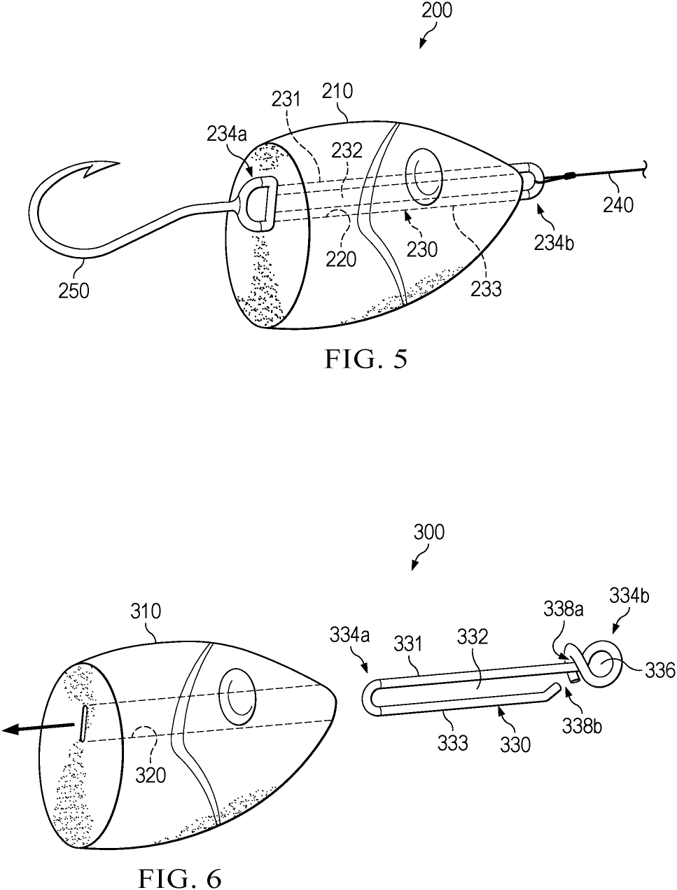

FIG. 5 illustrates another implementation of a link fishing lure system 200 comprising an enclosure 210, a channel 220, and a connecting link 230. In an implementation, the connecting link 230 contains no openings and includes an integrated hook 250 at an end 234a of the connecting link 230. The end 234a of the connecting link 230 with an integrated hook 250 is larger than the channel 220. The opposite end 234b and at least part of the body 232 of the connecting link 230 is sized to fit through the channel 220.

The connecting link 230 in the fishing lure system 200 illustrated in FIG. 5 may be secured by inserting the end 234b of the connecting link 230 without an integrated hook 250 into the channel 220 until the end 234b of the connecting link 230 protrudes past the enclosure 210. Once a clip-on attachment 240 is coupled to the end 234b of the connecting link 230, the connecting link 230 is secured within the channel 220 and within the enclosure 210.

FIG. 6 illustrates yet another implementation of a link fishing lure system 300 comprising an enclosure 310, a channel 320 and a connecting link 330. The connecting link 330 comprises a body 332 with substantially straight segments 331, 333 extending between and coupling to an end 334a that forms a half circle and an end 334b that forms an open figure eight 336. The connecting link 330 contains two openings 338a, 338b. One opening 338a is in the open figure eight 336 and the other opening 338b is on substantially straight segment 333, adjacent to the open figure eight 336. In this implementation of the connection link 332, both openings 338a, 338b may couple eye-style or clip-on attachments by threading. The channel 320 is shaped to allow the connecting link 330 to be inserted from either end of the channel 320.

The connecting link 330 in the fishing lure system 300 illustrated in FIG. 6 may be secured by first threading an attachment through one of the openings 338a, 338b in the connecting link 330 until the attachment reaches one end 334b. Alternatively, a clip-on attachment may be coupled directly on the end 334b. The opposite end 334a of the connecting link 330 may then be inserted into the channel 320 until the end 334a of the connecting link 330 protrudes past the enclosure 310. A clip-on attachment may then be coupled to the end 334a of the connecting link 330. Once an attachment is coupled to each end 334a, 334b of the connecting link 330, the connecting link 330 is secured within the channel 320 and within the enclosure 310.

The connecting link 330 in the fishing lure system 300 illustrated in FIG. 6 may be secured by inserting an end 334a, 334b of the connecting link into the channel 320 until the end 334a, 334b of the connecting link 330 protrudes past the enclosure 310. A clip-on attachment may then be coupled to one end 334a of the connecting link 330. Another clip-on attachment may be coupled to the opposite end 334b of the connecting link 330, or the attachment may be threaded on the opposite end 334b of the connecting link 330 via opening 338a in the open figure eight 336. Once an attachment is coupled to each end 334a, 334b of the connecting link 330, the connecting link 330 is secured within the channel 320 and within the enclosure 310.

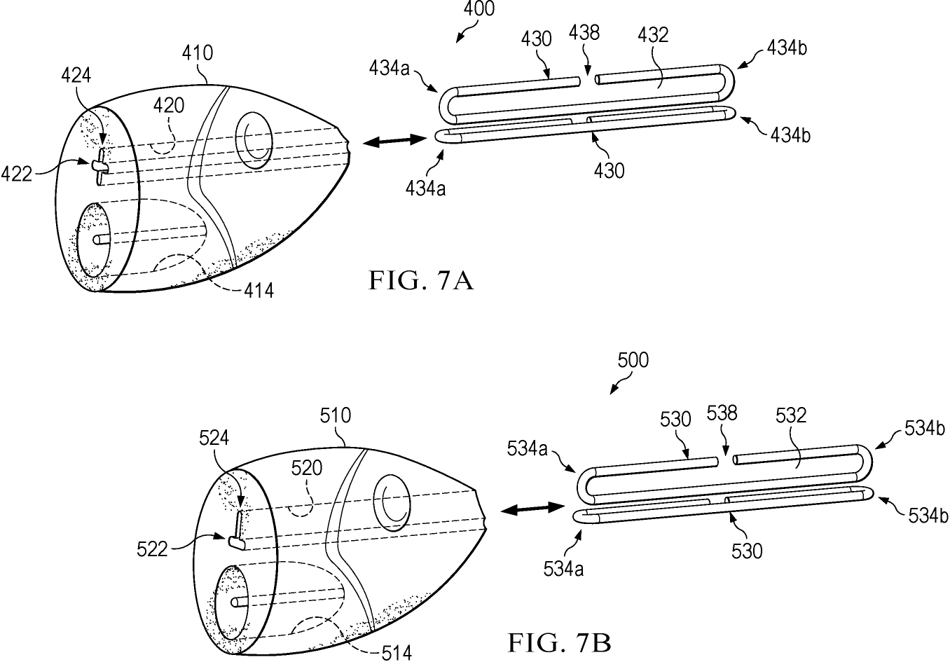

FIGS. 7A and 7B illustrate additional implementations of link fishing lure systems 400, 500, wherein the channel 420, 520 in the enclosure 410, 510 in the fishing lure system 400, 500 may accept a connecting link 430, 530 in multiple planes within the enclosure 410, 510. As shown in FIG. 7A, the channel 420 may be formed in the shape of a cross having a horizontal part 422 and a vertical part 424. Similarly, as shown in FIG. 7B, the channel 520 may be formed in the shape of an inverted T with a horizontal part 522 and a vertical part 524. In various implementations, the shapes of the channels 420, 520 may allow the connecting links 430, 530 to enter the horizontal parts 422, 522 of the channel 420, 520 or the vertical parts 424, 524 of the channel 420, 520. In other implementations, the channels may include parts that occur at angles that are not horizontal or vertical. This versatility may allow the link fishing lure system to adjust to the attachments available to a user.

The connecting links 430, 530 in the fishing lure systems 400, 500 illustrated in FIGS. 7a and 7b may be formed like the connecting link 130 shown in FIG. 1 with a long oval body 432, 532 having an opening 438, 538. As such, the connecting links 430, 530 may be secured within either the horizontal part 422, 522 of the channel 420, 520 or within the vertical part 424, 524 of the channel 420, 530 using attachments in the various manners described above with respect to FIG. 4. Once an attachment is coupled to each end 434a-b, 534a-b of the connecting link 430, 530, the connecting link 430, 530 is secured within the horizontal part 422, 522 of the channel 420, 520 or within the vertical part 424, 524 of the channel 420, 530 and within the enclosure 410, 510.

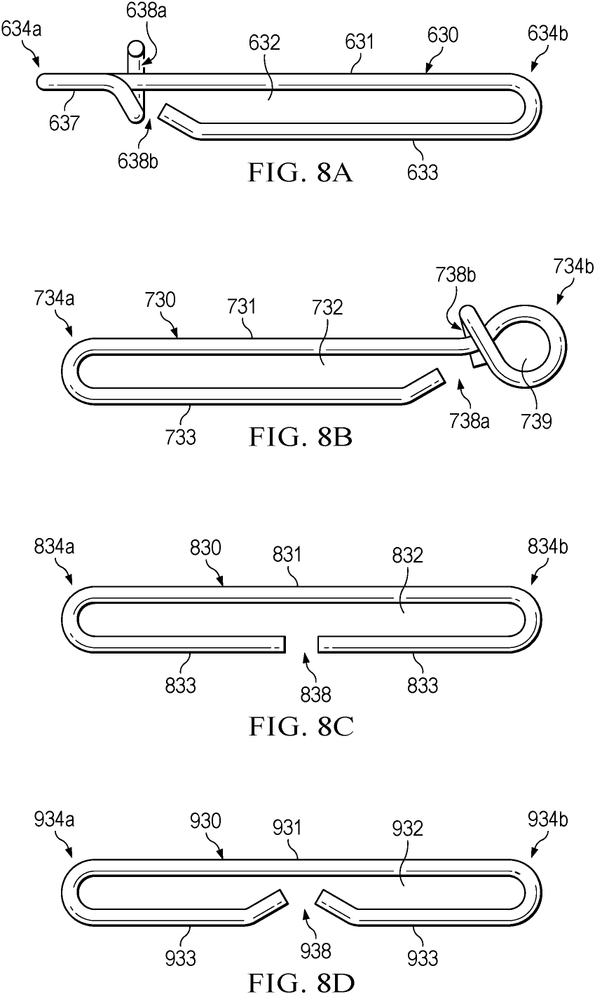

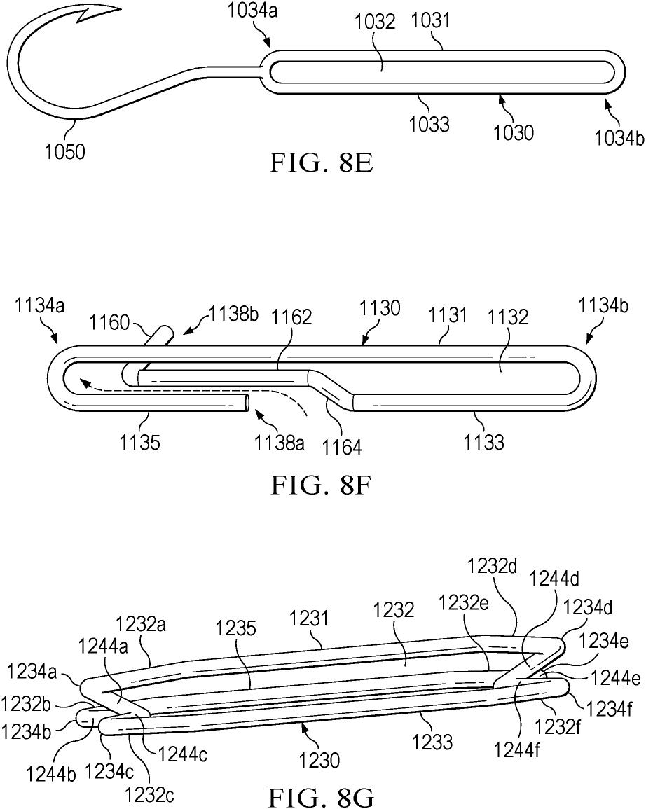

FIGS. 8A, 8B, 8C, 8D, 8E, 8F, and 8G illustrate several additional implementations of connecting links 630, 730, 830, 930, 1030, 1130. Whether an attachment can be threaded or clipped on to the connecting link 630, 730, 830, 930, 1030, 1130 is dependent on the geometry of the connecting link 630, 730, 830, 930, 1030, 1130 itself and the corresponding channel in the fishing lure system.

In the implementation of the connecting link 630 of FIG. 8A, the connecting link 630 comprises two substantially straight segments 631, 633, an opening loop 637 on an end 634a, a curved end 634b, and two openings 638a, 638b. Thus, the connecting link 630 contains two openings 638a, 638b in the body 632 where an attachment can be coupled. The first opening 638a is in the opening loop 637 and the second opening 638b is on substantially straight segment 633 near the opening loop 637. The openings 638a, 638b allow an eye attachment to be coupled by threading or a clip-on attachment to attach to both ends 634a-b. In the fishing lure system, an eye attachment cannot couple to both ends 634a-b of the connecting link 630 because it is not possible to both couple an eye attachment at each end and secure the connecting link 630 within the channel of the enclosure. The substantially straight segments 631, 633 keep the connecting link 630 secure in the direction perpendicular to the length of the channel. The end 634a creates an opening loop 637 that allows an attachment to slide onto the end 634a by applying slight pressure and opening the opening 638a. Without pressure, the opening loop 637 is pressed against itself to couple the attachment and close the loop on the end 634a.

In the implementation of the connecting link 730 of FIG. 8B, the connecting link 730 comprises two substantially straight segments 731, 733, an open figure eight 739 on an end 734b, a curved end 734a, and two openings 738a, 738b. The first opening 738a is on the substantially straight segment 733 near the open figure eight 739 and the second opening 738b is in the open figure eight 739. The two openings 738a, 738b in the connecting link 730 can couple attachments. The openings 738a, 738b allow an eye attachment to be coupled by threading or a clip-on attachment to attach to both ends 734a, 734b. In the fishing lure system, an eye attachment cannot couple to both ends 734a-b of the connecting link 730 because it is not possible to both couple an eye attachment at each end and secure the connecting link 730 within the channel of the enclosure. The substantially straight segments 731, 733 keep the connecting link 730 secure in directions along a plane perpendicular to the channel to the channel. The end 734b creates an open figure eight 739 that allows an attachment to slide onto the end 734b by applying slight pressure and opening the opening 738b in the open figure eight 739. Without pressure, the open figure eight 739 is pressed against itself to couple the attachment and close the open figure eight 739 on the end 734b.

In the implementation of the connecting link 830 of FIG. 8C, the connecting link 830 comprises two substantially straight segments 831, 833, two curved ends 834a, 834b, and one opening 838. The opening 838 is approximately in the middle of substantially straight segment 833, and an attachment can be coupled to either end 834a, 834b through the opening 838. The opening 838 allows an eye attachment to be coupled by threading, or clip-on attachments may be attached at either end 834a, 834b. In a fishing lure system, an eye attachment cannot couple to both ends 834a-b of the connecting link 830 because it is not possible to both couple an eye attachment at each end and secure the connecting link 830 within the channel of the enclosure. The substantially straight segments 831, 833 keep the connecting link 830 secure in the direction perpendicular to the channel.

In the implementation of the connecting link 930 of FIG. 8D, the connecting link 930 comprises two substantially straight segments 931, 933, two curved ends 934a, 934b, and one angled opening 938. The opening 938 is approximately in the middle of the substantially straight segment 933, and an attachment can be coupled to either end 934a, 934b through the opening 938. The substantially straight segment 933 is angled inward at both ends of the opening 938 to reduce the possibility of an attachment coupled to the connecting link 930 from uncoupling when the connecting link 930 is not within the channel 920. The opening 938 allows an eye attachment to be coupled by threading, or clip-on attachments may be attached at either end 934a, 934b. In a fishing lure system, an eye attachment cannot couple to both ends 934a, 934b of the connecting link 930 because it is not possible to both couple an eye attachment at each end and secure the connecting link 940 within the channel of the enclosure. The substantially straight segments 931, 933 keep the connecting link 930 secure in the direction perpendicular to the channel.

In the implementation of the connecting link 1030 of FIG. 8E, the connecting link 1030 comprises two substantially straight segments 1031, 1033, two curved ends 1034a, 1034b, and an integrated hook 1050. The integrated hook 1050 is located on an end 1034a, 1034b of the connecting link, such as end 1034a as shown in FIG. 8E. A clip-on attachment may be coupled on either end 1034a, 1034b, including the end 1034a with the integrated hook 1050. If an end 1034a is bigger than the channel, the connecting link 1030 may be secured within the channel by coupling an attachment at the other end 1034b. If an end 1034a is not bigger than the channel, the connecting link 1030 may be secured within the channel by coupling an attachment at both ends 1034a, 1034b. The substantially straight segments 1031, 1033 keep the connecting link 1030 secure in the direction perpendicular to the channel.

In the implementation of the connecting link 1130 of FIG. 8F, the connecting link 1130 comprises three substantially straight segments 1131, 1133, 1135, a weight securing prong 1160, a straight internal segment 1162, a bent segment 1164, and two openings 1138a, 1138b. The bent segment 1164 is coupled between substantially straight segment 1133 and straight internal segment 1162, to which the weight securing prong 1160 is coupled. The first opening 1138a is on the substantially straight segment 1135 and the second opening 1138b is on the weight securing prong 1160. The two openings 1138a, 1138b in the connecting link 1130 can couple attachments. In a fishing lure system, the openings 1138a, 1138b allow an eye attachment to be coupled to an end 1134a by threading or a clip-on attachment to attach to both ends 1134a, 1134b. In a fishing lure system, an eye attachment cannot couple to an end 1134b of the connecting link 1130 because it is not possible to both couple an eye attachment at the end 1134b and secure the connecting link 1130 within the channel of the enclosure. The substantially straight segments 1131, 1133, 1135 keep the connecting link 1130 secure in directions along a plane perpendicular to the channel. When the connecting link is secured within an enclosure, the weight securing prong 1160 extends across and blocks the weighting compartment to secure a weight within the weighting compartment. When the weight securing prong 1160 does not block the weighting compartment, the user may adjust the weight in the weighting compartment.

In the implementation of the connecting link 1230 of FIG. 8G, the connecting link 1230 comprises three substantially straight segments 1231, 1233, 1235 that are not all in the same plane, six angled segments 1232a, 1232b, 1232c, 1232d, 1232e, 1232f that couple the straight segments 1231, 1233, 1235 to one another, and six ends 1234a, 1234b, 1234c, 1234d, 1234e, 1234f, each positioned between a straight segment and an angled segment 1244a, 1244b, 1244c, 1244d, 1244e, 1244f. A clip-on attachment may be coupled to any end 1234a, 1234b, 1234c, 1234d, 1234e, 1234f. The connecting link 1230 may be secured within a channel by both coupling one or more attachments at one or more of the ends within a set of ends 1234a, 1234b, 1234c and by coupling one or more attachments at one or more of the ends within a second set of ends 1234d, 1234e, 1234f. The substantially straight segments 1231, 1233, 1235 keep the connecting link 1230 secure in the direction perpendicular to the channel.

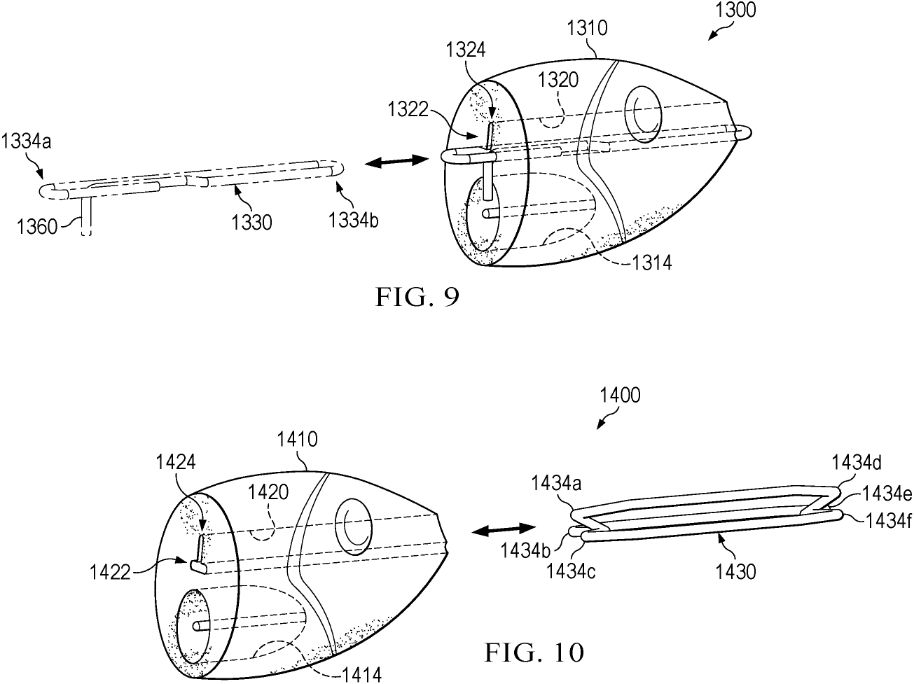

FIG. 9 illustrates yet another implementation of a link fishing lure system 1300 comprising an enclosure 1310, a channel 1320 comprising a horizontal part 1322 and a vertical part 1324, a connecting link 1330, and a weighting compartment 1314. The connecting link 1330 includes a weight securing prong 1360. When the connecting link 1330 is positioned within the horizontal part 1322 of the channel 1320, the weight securing prong 1360 is operable to both secure a weight within the weighting compartment 1314 and to secure the connecting link 1330 within the enclosure 1310. In this implementation, when the connecting link 1330 is positioned within the vertical part 1324 of the channel 1320, the weight securing prong 1360 is operable to secure the connecting link 1330 within the enclosure 1310 without securing a weight within the weighting compartment 1314.

FIG. 10 illustrates yet another implementation of a link fishing lure system 1400 comprising an enclosure 1410, a channel 1420 comprising a horizontal part 1422 and a vertical part 1424, a connecting link 1430, and a weighting compartment 1414. The connecting link 1430 may be three-dimensional, such as the connecting link 1230 of FIG. 8f, with six ends 1434a, 1434b, 1434c, 1434d, 1434e, 1434f that may couple to a clip-on attachment. The six ends may allow a user to couple multiple attachments on each side of the enclosure without having to couple multiple attachments on a single end. Six ends 1234a, 1234b, 1234c, 1234d, 1234e, 1234f may allow a user to have greater flexibility when configuring a lure. In this implementation, when the connecting link 1430 is positioned within the channel 1420, two of the straight segments extend into the horizontal part 1422 of the channel 1420, while the third straight segment extends into the vertical part 1424 of the channel 1420. The connecting link 1430 may be secured within the channel 1420 by both coupling one or more attachments at one or more of the ends within a set of ends 1434a, 1434b, 1434c and by coupling one or more attachments at one or more of the ends within a second set of ends 1434d, 1434e, 1434f. The substantially straight segments 1431, 1433, 1435 keep the connecting link 1430 secure in the direction perpendicular to the channel.

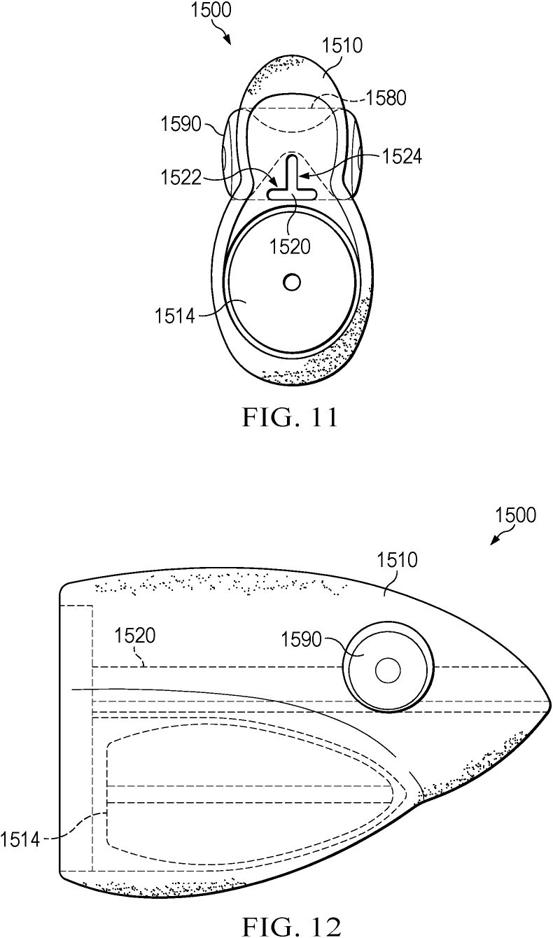

FIG. 11 illustrates a back end view, and FIG. 12 illustrates a side view, of still another implementation of a link fishing lure system 1500 comprising an enclosure 1510, a channel 1520, an optional weighting compartment 1514, an eye canal 1580, and a dumbbell eye capsule 1590 positioned within the eye canal 1580. The optional weighting compartment 1514 may house a weight. The channel 1520 may include a horizontal part 1522 and a vertical part 1524. The channel 1520 may house a connecting link that may be secured within the channel 1520 of the enclosure 1510. In this implementation, both parts 1522, 1524 of the channel 1520 run along the enclosure 1510, substantially perpendicular to the eye canal 1580. In other implementations, the channel 1520 does not run substantially perpendicular to the eye canal 1580. The eye canal 1580 and channel 1520 are connected at an intersection. In the implementation of FIG. 11, the eye canal 1580 has dimensions sufficient to slide the dumbbell eye capsule 1590 into the eye canal 1580. The eye canal 1580 is operable to removably house the dumbbell eye capsule 1590 or another type of eye capsule.

When inside the eye canal 1580, the eye capsule 1590 is positioned to allow a connecting link to be positioned into and secured within the channel 1520 of the enclosure 1510, which also secures the eye capsule 1590 within the eye canal 1580 of the enclosure 1510. The eye capsule 1590 is secured within the eye canal 1580 of the enclosure 1510 when the eye capsule 1590 is not removable from the eye canal 1580 when a force-which is insufficient to cause damage to the eye capsule, eye canal, connecting link, channel, enclosure, or an attachment-is applied to any or multiple ends of the eye capsule 1590.

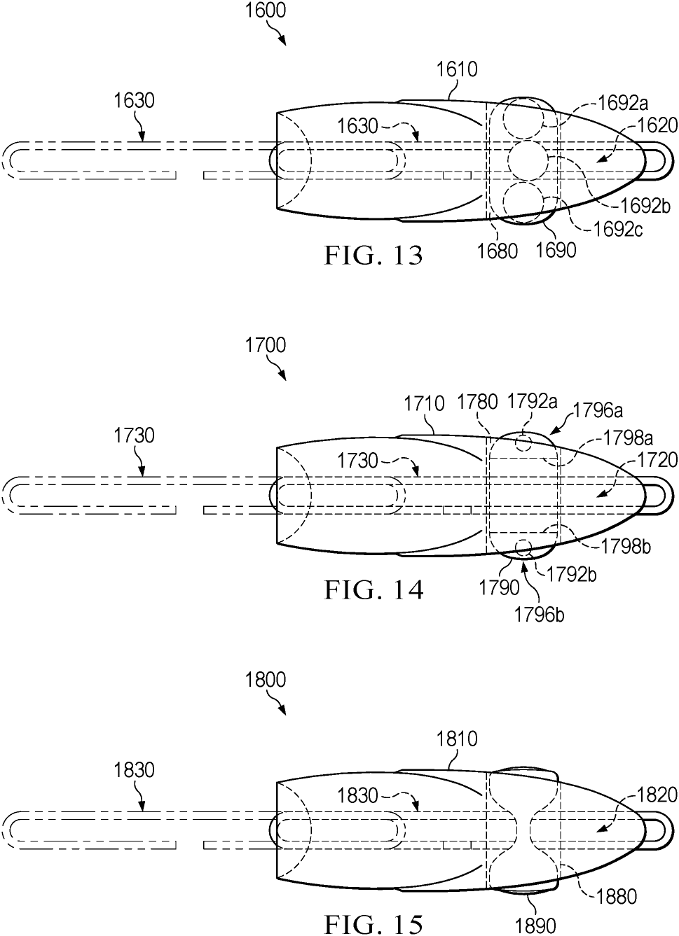

FIG. 13 illustrates a top down view of yet another implementation of a link fishing lure system 1600 comprising an enclosure 1610, a channel 1620, a connecting link 1630, an eye canal 1680, and an eye capsule 1690. The eye capsule 1690 comprises rattles 1692a, 1692b, 1692c that move within the eye capsule 1690 to produce a sound when the link fishing lure system 1600 is in use. In one implementation, the eye capsule 1690 may be secured within the eye canal 1680 of the enclosure 1610 by sliding the eye capsule 1690 into the eye canal 1680, then sliding the connecting link 1630 into the channel 1620, then securing the connecting link 1630 within the enclosure 1610, such as by coupling attachments. Once the connecting link 1630 is secured within the channel 1620, the eye capsule 1690 is also secured within the eye canal 1680.

FIG. 14 illustrates a top down view of still another implementation of a link fishing lure system 1700 comprising an enclosure 1710, a channel 1720, a connecting link 1730, an eye canal 1780, and an eye capsule 1790 with rattling eyes 1796a, 1796b. The eye capsule 1790 comprises rattles 1792a, 1792b that move within the eye capsule 1790 to produce a sound when the link fishing lure system 1700 is in use. The eye walls 1798a, 1798b inside the eye capsule 1790 keep the rattles 1792a, 1792b isolated at the ends of the eye capsule 1790 and create the rattling eyes 1796a, 1796b. The walls 1798a, 1798b may be solid or perforated and may change the sound the eye capsule 1790 creates when the link fishing lure system 1700 is in use. In some implementations, the eye capsule 1790 with rattling eyes 1796a, 1796b may contain one or more additional rattles in the space between the walls 1798a, 1798b. In one implementation, the eye capsule 1790 may be secured within the eye canal 1780 of the enclosure 1710 by sliding the eye capsule 1790 into the eye canal 1780, then sliding the connecting link 1730 into the channel 1720, then securing the connecting link 1730 within the enclosure 1710, such as by coupling attachments. Once the connecting link 1730 is secured within the channel 1720, the eye capsule 1790 is also secured within the eye canal 1780.

FIG. 15 illustrates a top down view of still another implementation of a link fishing lure system 1800 comprising an enclosure 1810, a channel 1820, a connecting link 1830, an eye canal 1880, and a dumbbell eye capsule 1890. The dumbbell eye capsule 1890 may fit tightly or loosely within the eye canal 1880. A dumbbell eye capsule 1890 that fits loosely within the eye canal 1880 may be used to change the sound the eye capsule 1890 creates when the link fishing lure system 1800 is in use. In one implementation, the eye capsule 1890 may be secured within the eye canal 1880 of the enclosure 1810 by sliding the eye capsule 1890 into the eye canal 1880, then sliding the connecting link 1830 into the channel 1820, then securing the connecting link 1830 within the enclosure 1810, such as by coupling attachments. Once the connecting link 1830 is secured within the channel 1820, the eye capsule 1890 is also secured within the eye canal 1880.

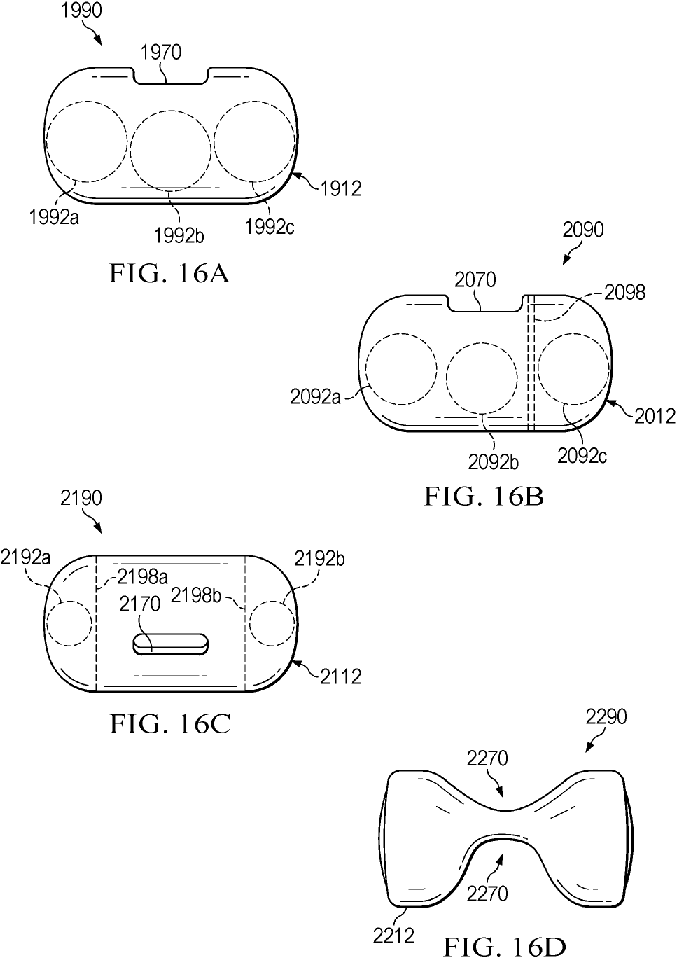

FIGS. 16A, 16B, 16C, and 16D illustrate top down views of several additional implementations of eye capsules 1990, 2090, 2190, 2290. When incorporating each of these eye capsules into a link fishing lure system, the geometry of the channel in the enclosure, the connecting link, the eye canal, and the eye capsule 1990, 2090, 2190, 2290 determines how the eye capsule 1990, 2090, 2190, 2290 should be positioned within the eye canal.

Referring now to FIG. 16A, the eye capsule 1990 comprises a container 1912, a cavity 1970, and rattles 1992a, 1992b, 1992c. The container 1912 houses the rattles 1992a, 1992b, 1992c. The cavity 1970 may allow the connecting link, when inserted into the channel of the enclosure in a specific orientation, to pass in and through the cavity 1970 and eye canal. When the eye capsule 1990 is inserted into the eye canal, the cavity 1970 should be aligned with the channel of the enclosure to allow a connecting link to pass through the portion of the channel common to both the channel and the eye canal. The eye capsule 1990 contains rattles 1992a, 1992b, 1992c that move within the eye capsule 1990 to produce a sound when the link fishing lure system is in use.

Referring now to FIG. 16B, eye capsule 2090 comprises a container 2012, a cavity 2070, a wall 2098, and rattles 2092a, 2092b, 2092c. The container 2012 houses the rattles 2092a, 2092b, 2092c. The wall 2098 is positioned internally of the container 2012 to separate rattle 2092c from the other rattles 2092a, 2092b and maintain each of the rattles 2092a, 2092b, 2092c within a certain portion of the container 2012. In various implementations, the wall 2098 may be positioned at any desired location internally of the container 2012. The cavity 2070 may allow the connecting link, when inserted into the channel of the enclosure in a specific orientation, to pass in and through the cavity 2070 and eye canal. When the eye capsule 2090 is inserted into the eye canal, the cavity 2070 cavity should be aligned with the channel of the enclosure to allow a connecting link to pass through the portion of the channel common to both the channel and the eye canal. The eye capsule 2090 contains rattles 2092a, 2092b, 2092c that move within the eye capsule 2090 to produce a sound when the link fishing lure system is in use. The wall 2098 may be solid or perforated and may change the sound the eye capsule 2090 creates when the link fishing lure system is used.

Referring now to FIG. 16C, eye capsule 2190 comprising a container 2112, a cavity 2170, walls 2198a, 2198b, and rattles 2192a, 2192b. The container 2112 houses the rattles 2192a, 2192b. The walls 2198a, 2198b are positioned internally of the container 2112 to separate the rattles 2192a, 2192b and maintain each of the rattles 2192a, 2192b within a certain portion of the container 2112. In various implementations, the walls 2198a, 2198b may be positioned at any desired location internally of the container 2012. The cavity 2170 may allow the connecting link, when inserted into the channel of the enclosure in a specific orientation, to pass in and through the cavity 2170 and eye canal. When the eye capsule 2190 is inserted into the eye canal, the cavity 2170 should be aligned with the channel of the enclosure to allow a connecting link to pass through the portion of the channel common to both the channel and the eye canal. The eye capsule 2190 contains rattles 2192a, 2192b that move within the eye capsule 2190 to produce a sound when the link fishing lure system is used by a user. The walls 2198a, 2198b may be solid or perforated and may change the sound the eye capsule 2190 creates when the link fishing lure system is in use.

Referring now to FIG. 16D, dumbbell eye capsule 2290 comprises a container 2212 and a cavity 2270. When the dumbbell eye capsule 2290 is inserted into the eye canal, the cavity 2270 should be aligned with the channel of the enclosure to allow a connecting link to pass through the portion of the channel common to both the channel and eye canal. The eye capsule 2290 may fit tightly or loosely within the eye canal. A dumbbell eye capsule 2290 that fits loosely within the eye canal may be used to change the sound the eye capsule 2290 creates when the link fishing lure system is in use.

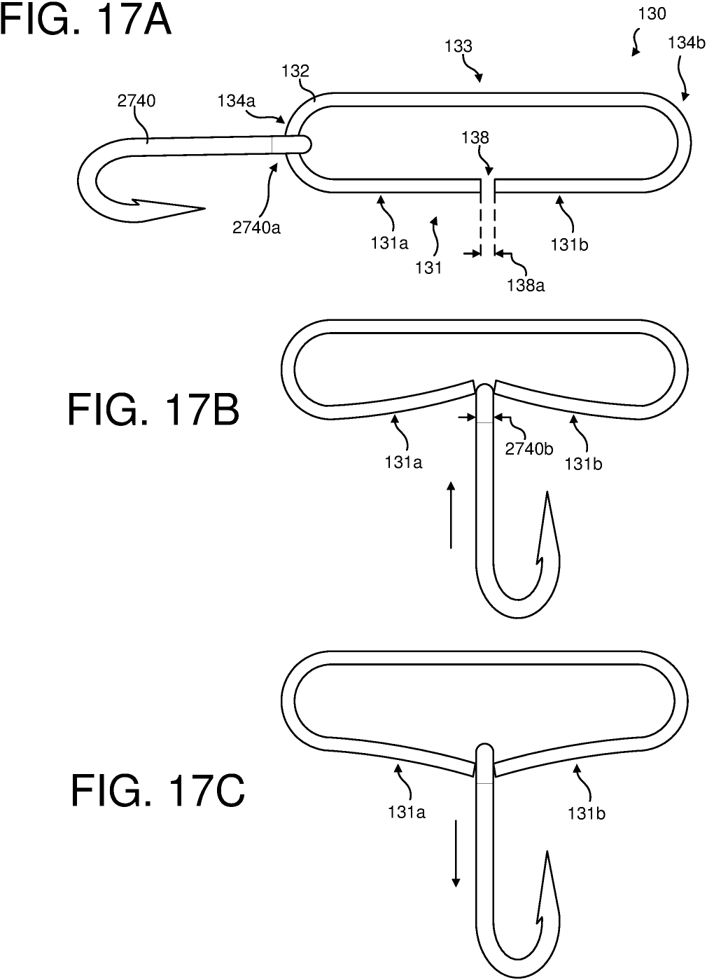

An exemplary implementation of the link 130 described with reference to FIGS. 1-4 is illustrated in FIGS. 17A-19B. As previously described, the link 130 is in the form of an open geometric stadium, having two curved ends 134a, 134b and two substantially straight segments 131, 133 extending from and between the ends 134a, 134b. One of the substantially straight segments 131 includes an opening (or “gap”) 138, which defines a first subsegment 131a connected to one end 134a and a second subsegment 131b connected to the other end 134b. The distance between the two subsegments 131a, 131b is the length 138a of the opening 138. This link 130 may be constructed from a flexible, elastic, resilient yet stiff material (e.g., metal wire or rod) such that the subsegments 131a, 131b may flex relative to the ends 134a, 134b.

In FIG. 17A, the link 130 is illustrated with a hook 2740 installed on the link 130 via a hook eye 2740a. The thickness 2740b of the hook 2740 at the eye 2740a may be slightly greater than the length 138a of the opening 138 to keep the hook 2740 from inadvertently falling off the link 130 when the link 130 is not secured in an enclosure. Thus, as illustrated in FIG. 17B, the subsegments 131a, 131b must flex to allow the hook 2740 to be inserted into the opening 138 such as to thread the hook eye 2740a on the link 130. Similarly, as illustrated in FIG. 17C, the subsegments 131a, 131b must flex to allow extraction of the hook 2740 from the link 130 through the link opening 138. For example, the length 138a of the opening 138 may be 0.055 inches and the thickness 2740b of the hook 2740 at the eye 2740a may be 0.060 inches. When not flexed by application of a force (e.g., insertion of the hook 2740 into the opening 138) the subsegments 131a, 131b should substantially return to their substantially straight state as shown FIG. 17 to hold the hook 2740 (or other attachment) on the link 130.

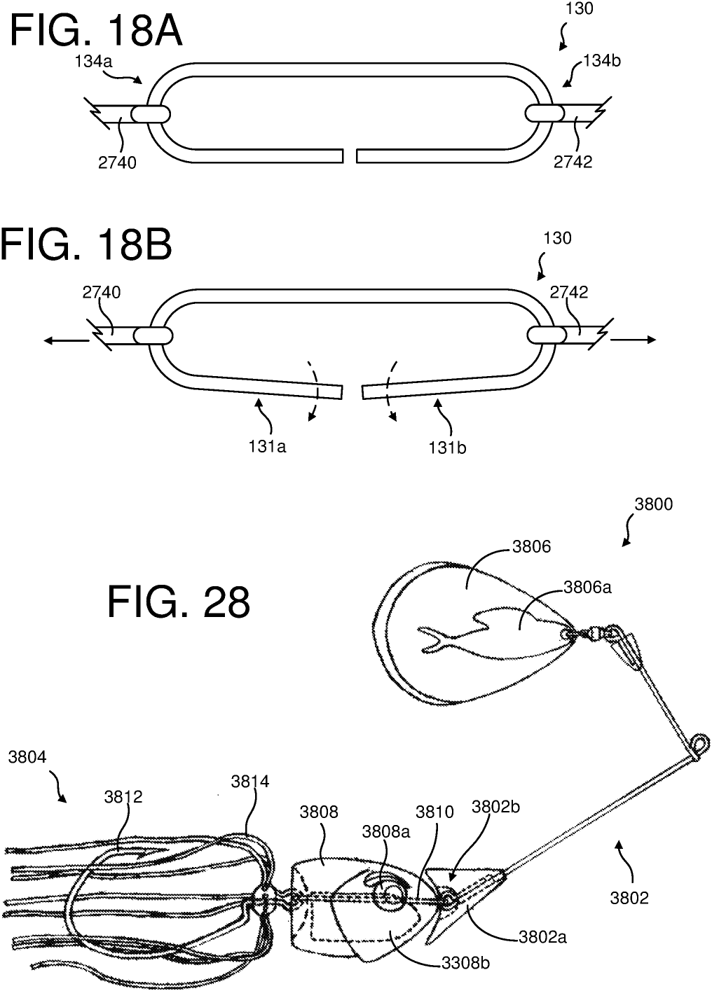

In FIGS. 18A-18B, the link 130 is illustrated linking two attachments 2740, 2742 connected at either end 134a, 134b (e.g., a hook 2740 and the wire frame of a spinnerbait 2742). In use, the link 130 mechanically connects the two attachments 2740, 2742 such that force applied to one will transferred to the other. For instance, the first attachment 2740 may be a hook taken by a fish and the second attachment 2742 may be connected to fishing line ultimately connected to a reel on a rod. The fish may pull the hook 2740 and thereby provide a force pulling on the line through the link 130 and second attachment 2742. This tension can cause the link 130 to distort as the subsegments 131a, 131b flex, potentially to the point the link 130 fails (e.g., it flexes to the point of breaking or straightening) and no longer connects the two attachments 2740, 2742 together. The fish escapes, with the hook 2740a.

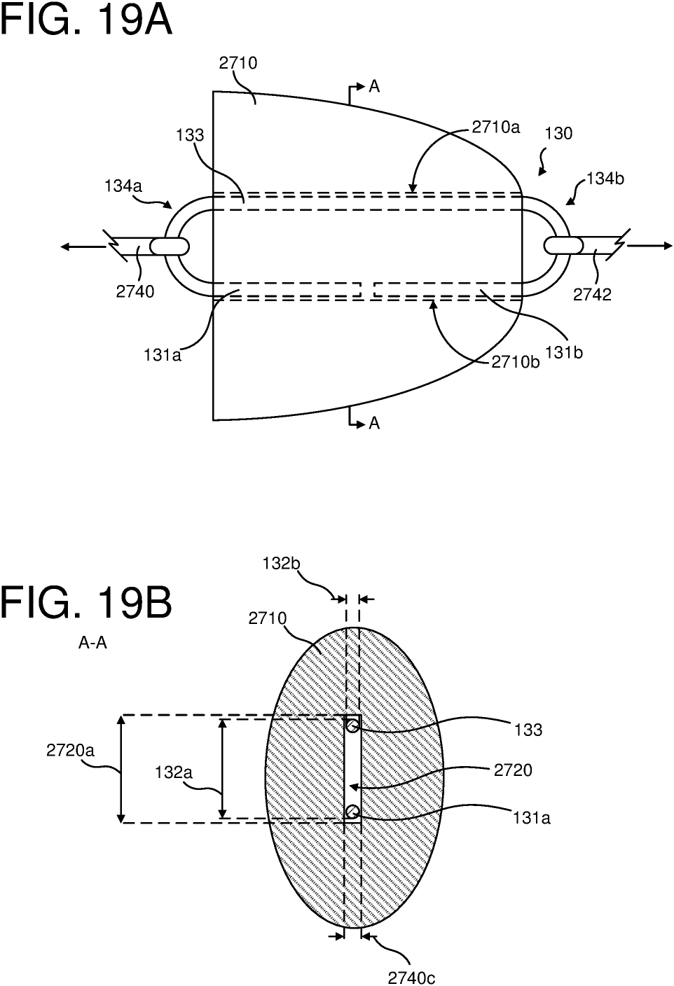

In FIGS. 19A-19B, the link 130 is illustrated secured in a channel 2720 extending through an enclosure 2710 made of a substantially rigid material, such as a hard plastic. Unlike the free-link situation illustrated in FIG. 18B, the link 130 is restrained by the substantially rigid walls 2710a, 2710b of the channel 2720. Thus, distortion of the link 130 due to tension applied to the link 130 via force applied to the link ends 134a, 134b will be constrained by the channel walls 2710a, 2710b, thereby preventing failure of the link 130 due to over-flexing. As illustrated in FIG. 19B, a sectional view of section A-A in FIG. 19A, the width 132a of the link 130 is slightly less than the width 2720a of the channel 2720. Thus, as the link 130 begins to flex and the subsegments 131a, 131b begin to flex out (as illustrated in FIG. 18B), the subsegment flexing will be limited by the subsegments 131a, 131b encountering a wall 2710b of the channel 2720 while the opposing link straight segment 133 encounters the opposing wall 2710a. The closer the channel width 2720a to the link width 132a, the less the link 130 will flex, assuming the channel walls 2710a, 2710b are constructed of a material that will not stretch when forced by the subsegments. For example, the channel width 2720a may be just 0.008 inches greater than the link width 132a, thus allowing the link 130 to be readily inserted into the channel 2720 but restricting the deflection of the link 130 to avoid failure of the link 130. (E.g., difference = channel width - link width, falls in the range 0.005 ≤ difference ≤ 0.010.) The thickness 2740c of the channel 2720 is slightly larger than the thickness 132b of the link 130. Preferably, the difference in the thicknesses 132b, 2740c is such that the channel 2720 serves to buttress the link 130 against flexing while allowing the link 130 to move within the channel thickness 2740c to rattle (ideally, in a manner that attracts fish). For example, the channel thickness 2740c may be about 0.020 inches larger than the link thickness 132b. As described above, the channel 2720 is of a shape and size to prevent the attachments 2740, 2742 from entering the channel. Movement of the attachment 2740, 2742 toward the channel is impeded when the attachment 2740, 2742 contacts the body 2710. Thus, when the link 130 is positioned in the channel 2720 and connected to attachments 2740, 2742 at either end 134a, 134b, the link 130 is both secured in the channel 2720 and structurally strengthened by the body 2710.

### Wire-Frame Attachment

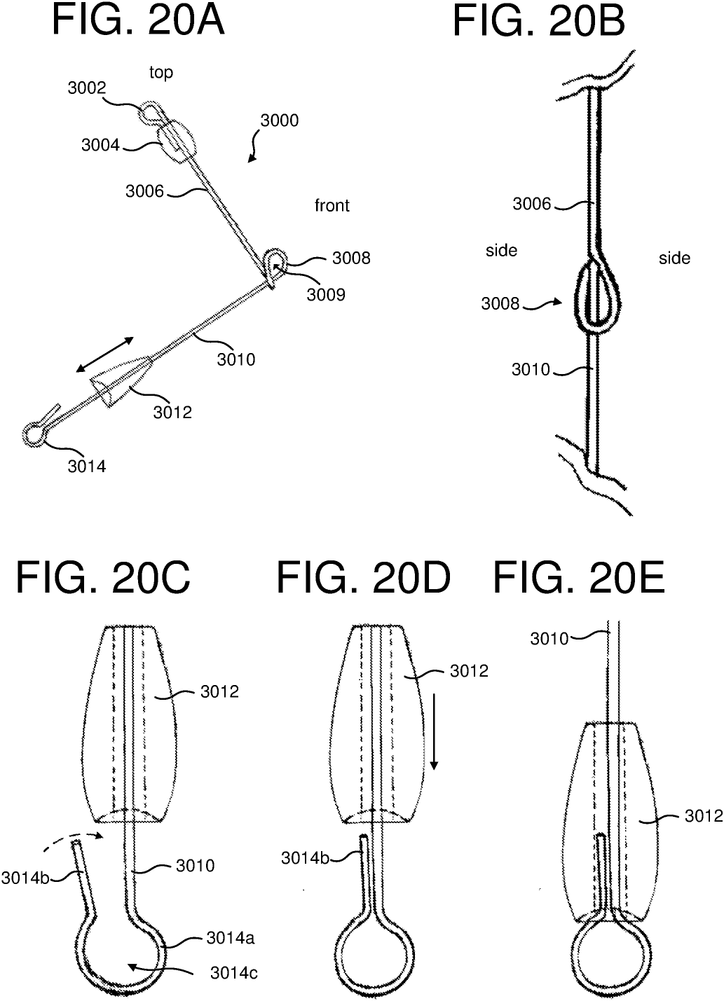

FIGS. 20A-20E illustrate an exemplary attachment 3000 for use with the link system described above. FIG. 20A is a side view of the attachment 3000, FIG. 20B is a front view of a bend portion of the attachment, and FIGS. 20C-20E are side views of an open loop and barrel portion of the attachment in various states. (The “front” and “side” are labeled in the figures.) The attachment 3000, in conjunction with the link system, is particularly useful for creating custom spinnerbait lures. The attachment 3000 includes a wire or rod body roughly in the shape of an “L”: the body is bent to define two elongated portions (“legs”) 3006, 3010 roughly 90 degrees (in the range of 80 - 100 degrees) to each other connected at a bend (or joint) 3008. Each of the elongated portions 3006, 3010 includes a proximal end (at the bend 3008) and a distal end (away from the bend 3008). The distal ends may each terminate in a closable open loop 3002, 3014 that enables connection to a link described above or other component. (Alternatively, one or both distal ends may terminate in a closed loop, like the hook eye previously described.)

The bend 3008 connecting the two legs 3006, 3010 is specially configured such that the body is bent back and wrapped about itself to form the two legs 3006, 3010 and a loop 3009. The structure of the bend 3008 may be understood with an exemplary process for creating it: a straight wire is bent roughly 180 degrees back on itself to form two roughly parallel straight sections joined by a first curved section; the first straight section is then bent roughly 90 degrees back on itself to form two roughly perpendicular sections joined by a second curved section wherein the first perpendicular section remains roughly parallel to the second straight section and the second perpendicular section crosses over the second straight section; the second perpendicular section is then bent roughly 180 degrees back on itself forming a third curved section that curves around the second straight section forming a loop and a portion extending out from the loop at roughly 90 degrees to the second straight section; then the portion that extends out from the loop at roughly 90 degrees to the second straight section may optionally be slightly bent to make it substantially coplanar with the second straight section and to substantially close the curve tightly around the second straight section. After the aforementioned bends are made, the portion of the first straight section that extends from the loop is roughly perpendicular to the portion of the second straight section that extends from the loop. The loop here corresponds to the loop 3009 of the attachment 3000. The portion of the first straight section that extends from the loop corresponds to the first leg 3006 of the attachment 3000. The portion of the second straight section that extends from the loop corresponds to the second leg 3010 of the attachment 3000. And the curved portions forming the loop correspond to the joint 3008 of the attachment 3000. Under tension, the third curved section forming the loop around the second leg 3010 will contact the second leg 3010 with minimal movement of the leg or loop and in so doing resist plastic deformation of the loop 3009 or the angle between the first 3006 and second 3010 legs. In the relaxed state, the third curved section should be within 50% of the largest inner dimension of the loop 3009 of the second leg 3010 (e.g., for a loop with a largest inner dimension of 0.25 inches, the third curved section will be within 0.125 inches of the second leg). The joint 3008 formed by the loop curves is referred to herein as the “looped means for connecting the first and second legs of a spinnerbait frame.”

An open barrel 3004, 3012 may be disposed along each of the elongated portions 3006, 3010 such that the elongated portion 3006, 3010 extends through the open interior of the barrel 3004, 3012 and such that the barrel 3004, 3012 may slide along the elongated portion 3006, 3010. The barrels 3004, 3012 may be constructed of a rigid material such as a hard plastic. (The barrels 3004, 3012 may be transparent, as shown, translucent, or opaque.)

The closeable open loops 3002, 3014 may be better understood with reference to FIGS. 20C-20E illustrating the closeable open loop 3014 and barrel 3012 of the second leg 3010. The loop 3014 is constructed of a portion of the lower-leg 3010 body bent back on itself to form a curved segment 3014a and straight segment 3014b. The curved segment 3014a defines a loop 3014c. The straight segment 3014b extends from the curved segment 3014a alongside the body of the second leg 3010 and may be elastically moved away from or toward the body of the second leg 3010 and thereby provide or close an opening to the loop 3014c. The closeable open loop 3014 is depicted in an open state in FIG. 20C, where the straight segment 3014b is positioned away from the body of the second leg 3010. The closeable open loop 3014 is depicted in a closed state in FIG. 20D, where the straight segment 3014b is positioned next to the body of the second leg 3010. The closeable open loop 3014 is depicted in a locked-closed state in FIG. 20E, where the straight segment 3014b is positioned next to the body of the second leg 3010 and the barrel 3012 is positioned so that its open interior encompasses the straight segment 3014b and the body of the second leg 3010. In the locked-closed state, the straight segment 3014b and the body of the second leg 3010 are in friction fit with the interior of the barrel 3012. Preferably, the closeable open loop 3014 is spring biased such that default position of the straight segment 3014b is the open position. This bias aids the friction fit with the barrel 3012, which serves to secure against undesired movement of the barrel to open the loop 3014. Preferably, the barrel 3012 is sufficiently rigid to structurally reinforce the loop 3014 to resist deformation of the loop 3014 when under tension (in a manner similar to the way the enclosure 2710 structurally reinforces the link 130, as described above).

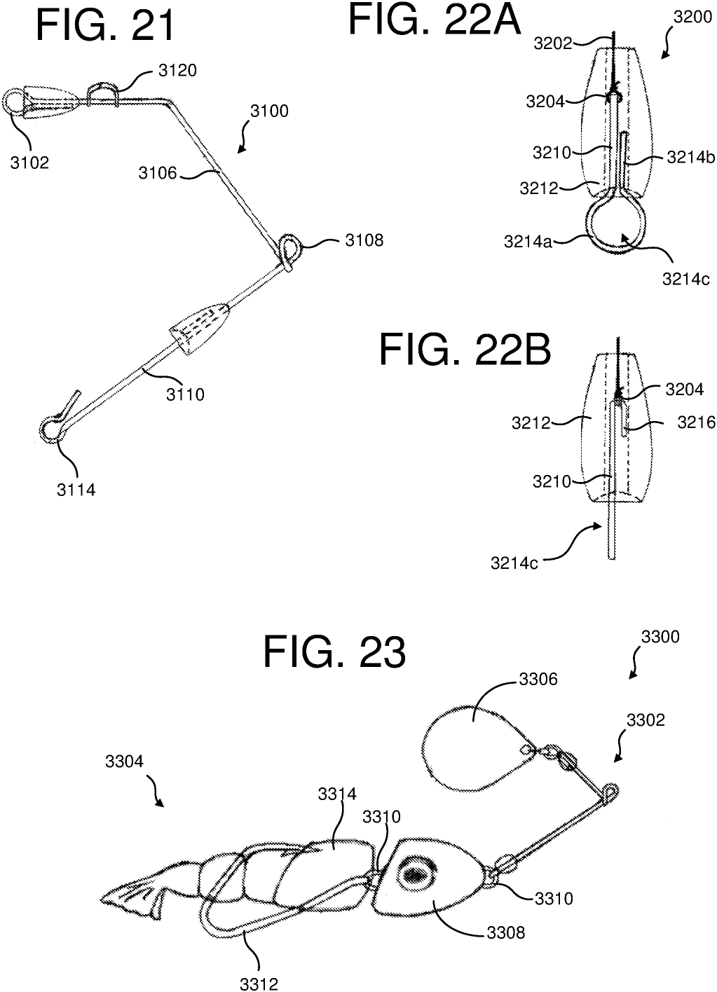

A variant of a spinnerbait-frame attachment 3100 is illustrated in FIG. 21. This is similar to the attachment 3000 of FIGS. 20A-20E but illustrates that the legs 3106, 3110 may be bent between the joint 3108 and the closeable open loops 3102, 3114 and the legs 3106, 3110 may include mounting features 3120 such as may be used to mount, e.g., blades to the attachment 3100.

Other attachments may be implemented with a closeable open loop. For example, as illustrated in FIG. 22A (front view) and FIG. 22B (side view), a line connector 3200 may include a closeable open loop comprising a curved segment 3214a and straight segment 3214b (similar to the curved and straight segments 3014a, 3014b described above) connected to a leg 3210 configured with a loop (or eye) to receive a fishing line 3202. The line connector 3200 further includes a barrel 3212 (similar to the barrel 3012 described above) that is positioned such the line may extend through the open interior of the barrel 3212 and such that the barrel 3212 may slide along the line 3202. The opening and closing of a loop 3214c defined by the curved 3214a segment is as described for the loop 3014c above. The barrel 3212 may be used to lock the connector in a closed-loop state in the same way that is described for the barrel 3012 above. Preferably, the knot 3204 connecting the line 3202 to the leg 3210 is positioned within the interior of the barrel 3212 when in the locked-closed position. This protects the knot during operation from, e.g., encounters with weeds or rocks. As illustrated in FIG. 22B, the connection between the line 3202 and leg 3210 may be a knot 3204 attached to a loop of the leg 3210 folded back on itself, with the folded-back segment 3216 secured in closed position by the barrel 3212 in a fashion similar to the securing of the lower loop’s straight segment 3214b by the barrel 3212..

### Lure System

An exemplary spinnerbait 3300 is illustrated in FIG. 23. The spinnerbait 3300 includes a first link attachment 3302 comprising a spinnerbait frame (similar to the attachment 3000 described with reference to FIGS. 20A-20E), a swimbait 3304 incorporating a link 3310 connected to first, lower, end of the frame 3302, and a blade 3306 connected to a second, upper, end of the frame. The swimbait 3304 includes a link 3310 disposed in a link enclosure 3308 in the form of a shrimp head (similar to the link enclosure 2710 described with reference to FIGS. 17A-19B) and hook 3312 disposed in a body 3314 in the form of a shrimp body. The hook 3312 is connected to one end of the link 3310 (similar to the hook 2740 described with reference to FIGS. 17A-17C) and the other end of the link 3310 is connected to the spinnerbait frame 3302. As illustrated, the shrimp head 3308 link-enclosure is opaque and includes an eye (which may be a weighted eye as described above); the shrimp body 3314 is substantially transparent and is constructed of a rubber or similarly soft, pliable, material; and the blade is opaque. As described below, the body and blade may be implemented in a variety of novel manners.

Another exemplary spinnerbait 3800 is illustrated in FIG. 28. This is similar to the spinnerbait 3300 illustrated in FIG. 23, but includes some innovative distinctions. For instance, the spinnerbait-frame attachment 3802 includes a specially configured locking barrel 3802a at the joint between frame 3802 and link 3810. This barrel 3802a is configured with a recess 3802b to encompass the joint between the link 3810 and the spinnerbait frame 3802. Another difference is that the link enclosure 3808 includes an eye 3808a and a weight 3308b that are similar to the weight 1514 and eye 1590 described with reference to FIGS. 11 and 12. Another difference is that the blade 3806 includes a fish-shaped component 3806a embedded in the body of the blade 3806. Another difference is that the body 3804 includes a skirt 3814. In one implementation, the connection between the body 3804 and the link 3810 retains the weight 3308b in the enclosure 3808. The body 3804 may also include a tied artificial fly (as is used in fly fishing) within the skirt 3814 or instead of the skirt 3814.

### Swimbait Bodies

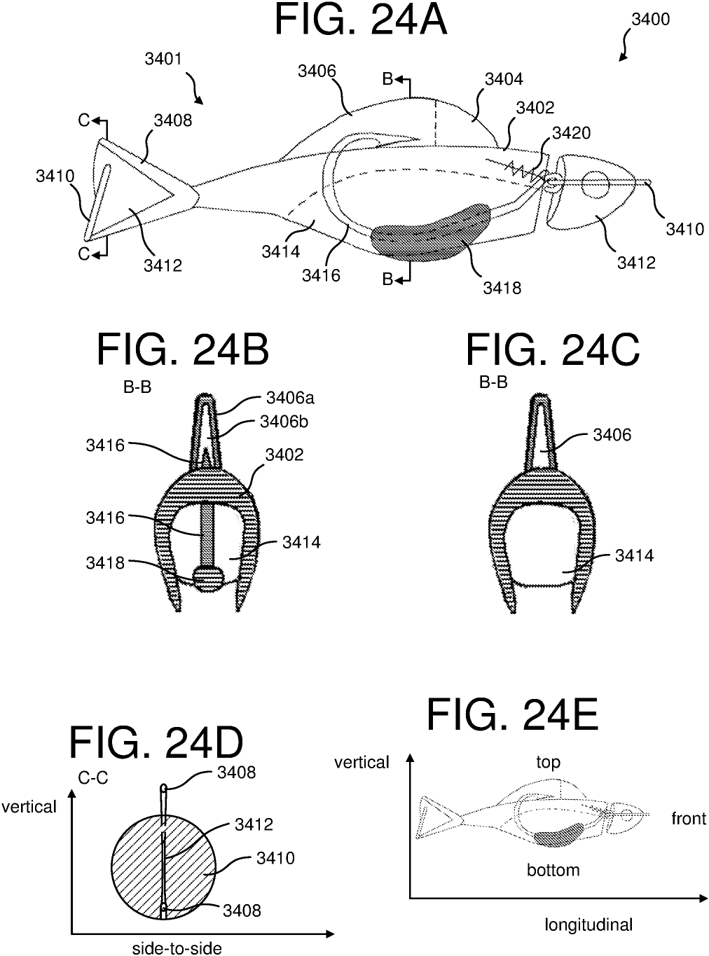

An exemplary swimbait 3400 is illustrated in FIGS. 24A-24D. FIG. 24A is a side view, FIGS. 24B and 24C are sectional views of section B-B, with and without an installed hook 3416, respectively. FIG. 24D is a sectional view of section C-C. The swimbait 3400 includes a link 3410 and link enclosure 3412 in the form of a fish head. These are similar to the link and link enclosure described with reference to FIGS. 17A-19B. The swimbait also includes a body 3401 attached to the link 3410 via a hook 3416 in the body. The body 3401 includes: (1) a main body 3402; (2) a first, solid, section 3404 of a dorsal fin; (3) a second, pocketed, section of a dorsal fin 3406; (4) a tail (caudal) fin defined by tail-fin ribs 3408 roughly in the form of a “Y” connected by a tail-fin membrane 3412; and (5) a main-body pocket 3414. The dorsal-fin pocket 3406b is defined by an outer portion 3406a and is configured to hold the barb section of a hook 3416 disposed in the body 3401. The main-body pocket 3414 is defined by the main body 3402, which is solid and thicker near the dorsal fin than at the sides, and is configured to hold the hook 3416, which may be weighted with a weight 3418. The dorsal-fin pocket 3406b and the main-body pocket 3414 are configured to encompass most or all of the hook 3416 and weight 3418 such that when the main body 3402 and pocketed dorsal fin 3406 are made from opaque material, the hook 3416 and weight 3418 are concealed when viewed from the side or top. (The body 3401 is illustrated as transparent in the figures.) The hook 3416 may be attached to the body with a screw or coil 3420.

A tail-fin disc 3410 is disposed on, or integral to, the tail. The plane of the tail-fin disc 3410 is roughly perpendicular to the plane of the tail-fin membrane 3412. (The dihedral angle between the two planes is between 80 degrees and 100 degrees.) The disc 3410 is slightly angled off perpendicular (vertical) with respect to the longitudinal axis of the fish body 3401, with the disc 3410 tilted such the top portion of the disc 3410 is nearer to the front of the body 3401 than is the bottom portion of the disc 3410. The plane of the tail-fin membrane 3412 is oriented substantially parallel to the vertical axis of the fish body 3401. As illustrated in FIGS. 24D and 24E, the longitudinal axis corresponds to the anteroposterior axis of the simulated fish and the vertical axis corresponds to the dorsoventral axis. In use, the tail-fin membrane 3412 provides a slip stream through the water and the disc 3410 provides resistance and drag in the water adding a side-to-side motion to the tail section when in motion.

### Spinner Blades

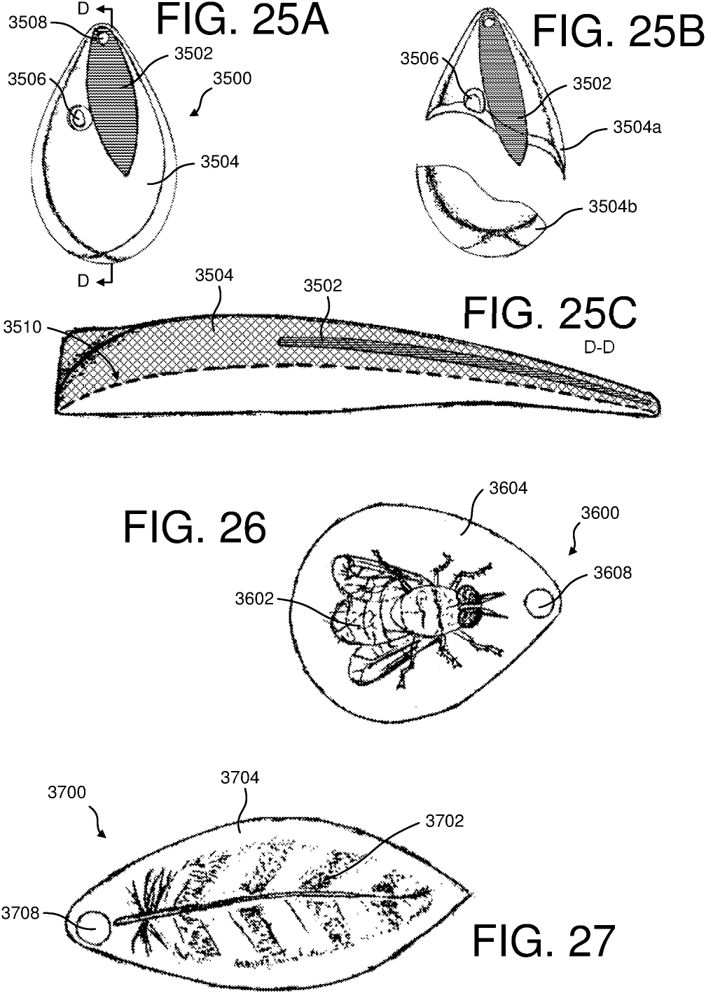

A variety of exemplary spinner blades 3500, 3600, 3700 are illustrated in FIGS. 25A-27. FIGS. 25A-25C are three views (facing, facing exploded, side sectional, respectively) illustrating a spinner blade 3500 that incorporates an inner blade 3502 within an outer blade 3504. The outer blade 3504 is preferably made of a transparent or translucent material such that the embedded inner blade 3502 is at least partially visible. For example, the outer blade 3504 may be constructed from a substantially transparent resin, perhaps dyed to a particular color scheme or pattern to effect areas of transparency, translucency, and/or opacity while still revealing at least portions of the embedded inner blade 3502. The inner blade 3502 may be, for example, a traditional metal blade painted with a particular color scheme or pattern. Alternatively, the inner blade 3502 may also be constructed and patterned to define areas of transparency, translucency, and/or opacity. The outer blade 3504 serves to protect the inner blade 3502—and its finish-from wear and tear during use, thus extending the life of the inner blade 3502. The outer blade 3504, as it is larger then the inner blade 3502, may also serve to provide a different spin rate than would be the case if the inner blade 3502 were to be used apart from the outer blade 3504. The outer blade 3504 and inner blade 3502 may also be configured such that the inner blade 3502 is off center to thereby provide a wobble to the spin of the spinner 3500 in use. (In contrast to a symmetric spinner blade, which will typically spin uniformly about its spin axis.) The spinner blade 3500 includes an attachment hole 3508 for connection to a link attachment such as the spinner frame described above or to a link. Preferably, the hole 3508 passes through both the outer blade 3504 and the inner blade 3502. The spinner blade 3500 may include a recess 3506 that serves as an eye socket within which to place a simulated fisheye. Preferably, the recess 3506 is deep enough to receive all or a substantial portion of the simulated fisheye, thereby protecting the simulated fisheye from wear and tear. As illustrated in FIG. 25B, a portion 3504b of the outer blade 3504 may be fractured apart from the blade 3500 during use, leaving a remaining portion 3504a and the inner blade 3502 such that the blade 3500 will continue to function (if less than ideally) to spin and draw the attention of fish. As illustrated in FIG. 25C (a sectional view of section D-D of FIG. 25A), the outer blade 3504 preferably has a concave surface 3510 on one side (it is “cupped”), providing a surface roughly in the shape of a spoon.

As illustrated in FIGS. 26 and 27, a blade 3600, 3700 may include embedded features beyond or different from an inner blade. For example, as illustrated in FIG. 26, a fly 3602 (real or simulated) may be embedded in an outer blade 3604 connectable to a link or link-attachment through an attachment hole 3608. The outer blade 3604 is similar in form and function to the outer blade 3504 described with reference to FIGS. 25A-25C above. In another example, as illustrated in FIG. 27, a feather 3702 (real or simulated) may be embedded in an outer blade 3704 connectable to a link or link-attachment through an attachment hole 3708. The outer blade 3704 is similar in form and function to the outer blade 3504 described with reference to FIGS. 25A-25C above.

### Manufacturing Process

The link enclosures, locking barrels, swimbait bodies, and blades described herein may be made using an injection-molding process. A model (positive) of a particular component may be constructed, e.g., by subtractive machining or whittling, by 3D printing, or by 3D modeling, and then a mold (negative) may created from the model. The void space of the mold may then be filled with a liquid such as a resin of select or customized as-cured or as-set optical characteristics (e.g., a dyed translucent or clear transparent material) and mechanical characteristics (e.g., pliable or rigid). Once the resin has been injected into the mold, it is cured or set to form the desired component. For example, a link enclosure shaped as a fish head may be constructed by: (1) appropriate machining or printing of fish features and link channel to form a physical model, (2) casting a two-part mold from this physical model; (3) assembling the mold, along with any desired embedded components; (4) injecting the assembled mold with an appropriate resin; (5) applying, as appropriate, a curing agent/condition to the injected resin or a setting period; (6) disassembling the mold and extracting the link enclosure. Instead of casting, a mold may be directly machined or printed from a 3D digital model of the component. A similar process may be used for any of the above-described components. For some components, it is preferable to use a low-temperature-cure material so that features may be embedded into the component without damaging the features.

For rigid components (e.g., link enclosure, locking barrel, blade) appropriate thermoplastic and thermoset materials include, e.g., polyurethane, epoxy, vinyl, acrylic, polycarbonate, polyvinyl chloride, polypropylene, polyethylene terephthalate, and phenols. For pliable/flexible components (e.g., swimbait body) appropriate elastomers include, e.g., PVC (polyvinyl chloride), polyurethane, silicones, and rubber. In some embodiments, a rigid component may be machined or cast of metal such as steel, iron, or lead. In some embodiments, a rigid component may be cast with a pliable/flexible material so long as doing so does not interfere with the purpose of the rigidity. For example, a link enclosure or locking barrel may include a silicone coating on the outside while leaving the interior channel uncoated.

The link fishing lure systems of the present disclosure may include an enclosure with a channel and a connecting link. Any appropriate enclosure, channel, and/or connecting link may be utilized. In some implementations, the enclosure may include a weighting compartment that can removably house a weight. In some implementations, the enclosure may contain a weighting compartment that can irremovably house a weight. In some implementations, the enclosure may lack a weighting compartment and lack a weight. The enclosure may be shaped like a fish or part of a fish.

The channel can removably house the connecting link. The connecting link can slidably move within the channel. The channel has a shape and size that allows at least two ends of the connecting link to extend sufficiently outside the enclosure to couple at least one attachment. In some implementations, the channel may be shaped to allow the connecting link to be inserted in a single plane within the enclosure. In some implementations, the channel may be shaped to allow the connecting link to be inserted in one of multiple planes within the enclosure.

The connecting link has a length at least sufficiently greater than the channel to couple at least one attachment. The connecting link may have a length at least sufficiently greater than the channel to couple to at least one attachment when the geometry of the channel and the connecting link itself secures an end of the connecting link when one attachment is coupled to the other end of the connecting link. The connecting link may have a length at least sufficiently greater than the channel to couple to at least two attachment when the geometry of the channel and the connecting link itself cause the connecting link to be secure if two ends of the connecting link are secured. In some implementations, the connecting link may have an opening that allows at least one attachment to be coupled onto the connecting link by threading. In some implementations, the connecting link may have multiple openings that allow at least one attachment to be coupled onto the connecting link by threading. In some implementations, the connecting link may lack any openings. The ends of the connecting link are the areas of the connecting link that do not touch the enclosure when the connecting link is secure and that cause the connecting link to be secured within the enclosure when one or more attachments are connected to one or more parts of the connecting link. In some implementations, the connecting link may have one or more ends shaped like an open figure eight, rounded, squared off, shaped like a V, shaped like an M, or other form. The body of the connecting link may include segments that are substantially straight, curved, wavy, zig-zagged, or any similar form that extends along the length of the connecting link.

The connecting link is placed by the user within the channel inside of the enclosure. Based on the shapes and sizes of the connecting link and channel, one or more attachments may be coupled to the connecting link in order to secure the connecting link within the enclosure. The connecting link should be secure when the link fishing lure system is used while fishing because the link fishing lure system may otherwise disassemble.

In some implementations, the connecting link may be shaped so that any end can be inserted into any entrance of the channel in order to house the connecting link within the enclosure. When any end of the connecting link can fit into any opening of the channel, an attachment is coupled to both ends of the connecting link in order to secure the connecting link within the enclosure.

In some implementations, the connecting link may be shaped so that only one of the ends can be inserted into one of the entrances of the channel in order to house the connecting link within the enclosure. When such a relationship is present between the connecting link and the channel, one of the ends naturally secures the connecting link without coupling an attachment to that end when the other end is coupled to an attachment.

In some configurations, a fishing line that is tied in a knot is a clip-on attachment. In some configurations, a hook with a clip style eye is a clip-on attachment. The attachment may be a fishing line, a metal line, an offset worm hook, fly fishing lure, salt water streamer, feathered treble hook, flipping hook, vertical hook eye swim bait hook, horizontal hook eye weighted hook, weighted hook with coil keeper, skip gap hook, open eye hook, closed eye hook, open eye shaft with sleeve, monofilament line, braided line, duo lock snap, cross lock snap, coast lock snap, inline spinnerbait wire forms, buzz bait wire forms, or other fishing attachment.

In some implementations, the link fishing lure systems of the present disclosure may further include an eye canal and an eye capsule. The eye capsule may have no rattles, a single rattle, or a plurality of rattles. The rattles within the eye capsule may differ in size and/or composition. The eye capsule may include a container with a cavity and with one or more walls positioned inside the container. The walls may be straight, angled, or curved. The walls may be solid or perforated. The walls may have openings sufficient to allow a rattle to pass through the wall. The eye capsule may be solid or hollow. The container of the eye capsule may be accessible to allow a user to reconfigure wall and/or rattle positioning. The dumbbell eye capsule may contain no walls, a single wall, or a plurality of walls. The dumbbell eye capsule may contain no rattles, a single rattle, or a plurality of rattles. Depending on the geometry and dimensions of the eye capsule and eye canal, it may be possible to insert the eye capsule from either one end or both ends of the eye canal. The eye capsule may have multiple cavities that, when at least one of the plurality of cavities is aligned with the channel, allow a connecting link to pass through the portion of the channel common to both the channel and eye canal.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a weight” includes a combination of two or more weights and reference to “an attachment” includes different types and/or combinations of attachments. Reference to a “weight compartment” may include a combination of two or weight compartments.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A fishing lure comprising:
(a) a substantially flexible link comprising a body in the form of an open geometric stadium including a first curved end, a second curved end, a first side, and a second side; wherein: the first end, second end, first side, and second side define a geometric-stadium-shaped opening; the body includes an inside surface facing the geometric-stadium-shaped opening and an outside surface facing away from the geometric-stadium-shaped opening; the second side includes a link gap, thereby dividing the second side into a first segment and a second segment; the link has an outer link width defined by the distance from the outside surface at the first side to outside surface at the second side; the link has an outer length defined by the furthest distance between the outside surface at the first curved end to the outside surface at the second curved end; and the link body has a link-body thickness; and
(b) a link-enclosure comprising a substantially rigid enclosure body and a substantially rectangular channel disposed within the substantially rigid enclosure body, wherein the channel has a channel width, a channel length, and a channel thickness; and
(c) wherein the outer link length is greater than the channel length and the outer link width is less than the channel width.

2. The fishing lure of claim 1 wherein the difference between the outer link width and the channel width is in the range of 0.005 to 0.010 inches.

3. The fishing lure of claim 1 wherein the difference between the outer link width and the channel width is in the range of 0.010 to 0.020 inches.

4. The fishing lure of claim 1 wherein the link-body thickness is less than the channel thickness and the difference between the link-body thickness and the channel thickness is in the range of 0.010 to 0.030 inches.

5. The fishing lure of claim 1 wherein the link-body thickness is less than the channel thickness and the difference between the link-body thickness and the channel thickness is in the range of 0.030 to 0.050 inches.

6. The fishing lure of claim 1 wherein the link is formed by bending an elongated component into the form of an open geometric stadium with a gap on one side, wherein the elongated component is one of the group consisting of a metal wire and a metal rod.

7. The fishing lure of claim 1 further comprising an attachment having a connecting component that is one of the group consisting of an eye comprising a closed loop of material with an outer thickness that is greater than the link gap and a clip comprising an open loop of material and having a loop gap that is greater than the link-body thickness.

8. The fishing lure of claim 1 further comprising a spinnerbait frame connected to the link, the spinnerbait frame comprising:
(a) a first leg having a first terminal end and a first joint end;
(b) a second leg having a second terminal end and a second joint end; and
(c) a looped means for connecting the first and second legs of a spinnerbait frame;
(d) wherein the first joint end is connected to the second joint end through the looped means for connecting the first and second legs of a spinnerbait frame.

9. The fishing lure of claim 8 further comprising:
(a) a first clip disposed at the first terminal end, the first clip comprising a first-clip curved segment connecting a first-clip straight segment to the first leg, wherein the first-clip curved segment defines a loop having a first loop gap, and the first-clip straight segment is selectively positionable away from the first leg to open the first loop gap and adjacent to the first leg to close the first loop gap;
(b) a first open barrel slidably disposed on the first leg and having an interior configured to fit over the first-clip straight segment when the first-clip straight segment is positioned adjacent to the first leg, thereby securing the first-clip straight segment in that position.

10. The fishing lure of claim 9 further comprising:
(a) a second clip disposed at the second terminal end, the second clip comprising a second-clip curved segment connecting a second-clip straight segment to the second leg, wherein the second-clip curved segment defines a loop having a second loop gap, and the second-clip straight segment is selectively positionable away from the second leg to open the second loop gap and adjacent to the first leg to close the second loop gap;
(b) a second open barrel slidably disposed on the second leg and having an interior configured to fit over the second-clip straight segment when the second-clip straight segment is positioned adjacent to the second leg, thereby securing the second -clip straight segment in that position.

11. The fishing lure of claim 8 further comprising a spinnerbait blade, wherein the spinnerbait blade includes an outer blade and an interior feature encompassed by the outer blade and wherein the spinnerbait blade is attached to one of the group consisting of the first terminal end and the second terminal end.

12. The fishing lure of claim 11 wherein the interior feature includes a second spinnerbait blade.

13. The fishing lure of claim 1 further comprising a swimbait body attached to the substantially flexible link, the swimbait body comprising:
(a) a hook configured to engage the link at the first curved end or the second curved end;
(b) a main body portion defining a main-body cavity configured to accept within itself at least a portion of the hook; and
(c) a dorsal fin portion extending in a first direction from the main body portion and defining a dorsal-fin cavity configured to accept within itself a portion of the hook.

14. The fishing lure of claim 13 wherein the swimbait body further includes a tail fin portion having a first planar surface and a second planar surface, the first and second planar surfaces forming a dihedral angle within the range of 80 degrees to 100 degrees.

15. The fishing lure of claim 14 wherein the first planar surface is substantially parallel to the first direction.

16. A spinnerbait frame comprising:
(a) a first leg having a first terminal end and a first joint end;
(b) a second leg having a second terminal end and a second joint end; and
(c) a looped means for connecting the first and second legs of a spinnerbait frame;
(d) wherein the first joint end is connected to the second joint end through the looped means for connecting the first and second legs of a spinnerbait-frame attachment.

17. The spinnerbait frame of claim 16 further comprising:
(a) a first clip disposed at the first terminal end, the first clip comprising a first-clip curved segment connecting a first-clip straight segment to the first leg, wherein the first-clip curved segment defines a loop having a first loop gap, and the first-clip straight segment is selectively positionable away from the first leg to open the first loop gap and adjacent to the first leg to close the first loop gap;
(b) a first open barrel slidably disposed on the first leg and having an interior configured to fit over the first-clip straight segment when the first-clip straight segment is positioned adjacent to the first leg, thereby securing the first-clip straight segment in that position.

18. The spinnerbait frame of claim 16 further comprising:
(a) a second clip disposed at the second terminal end, the second clip comprising a second-clip curved segment connecting a second-clip straight segment to the second leg, wherein the second-clip curved segment defines a loop having a second loop gap, and the second-clip straight segment is selectively positionable away from the second leg to open the second loop gap and adjacent to the first leg to close the second loop gap;
(b) a second open barrel slidably disposed on the second leg and having an interior configured to fit over the second-clip straight segment when the second-clip straight segment is positioned adjacent to the second leg, thereby securing the second -clip straight segment in that position.
